(19) United States
(12) Patent Application Publication
(10) Pub. No.: US 2018/0362684 A1
(43) Pub. Date: Dec. 20, 2018

(54) High Viscosity Metallocene Polymers with Low Volatiles Content

(71) Applicant: ExxonMobil Chemical Patents Inc., Baytown, TX (US)

(72) Inventors: Yu Feng Wang, Houston, TX (US); Cameron Y. Lim, Baton Rou, LA (US); Aaron H. Reed, League City, TX (US)

(21) Appl. No.: 16/063,321

(22) PCT Filed: Dec. 9, 2016
(86) PCT No.: PCT/US2016/065728

§ 371 Date: Jun. 18, 2018

Related U.S. Application Data
(60) Provisional application No. 62/281,892, filed on Jan. 22, 2016.

(30) Foreign Application Priority Data
Apr. 28, 2016 (EP) 16167400.7

(51) Int. Cl. C08F 210/18; C08F 2/01; C08F 6/10; C08L 23/16; B29B 7/16; B29B 7/74

(52) U.S. Cl. CPC C08F 210/18; C08F 2/01; C08F 6/10; C08F 2500/17; B29B 7/16; B29B 7/7495; C08L 2314/06; C08L 23/16

(57) ABSTRACT

High Mooney viscosity elastomers having low volatiles content, and processes for producing such elastomers, are provided herein. In particular aspects, the elastomers are metallocene-catalyzed elastomers, such as mEPDM elastomers. Processes for producing such elastomers include devolatilization of an elastomer stream comprising such elastomers, using a kneader. The kneader is counterintuitively operated such that the internal agitating paddles rotate at relatively low speeds. It is believed these low speeds help maintain the elastomer stream as a toffee-like composition, preventing the elastomer stream within the kneader from becoming a crumbly composition, which is difficult to devolatilize.

### CROSS-REFERENCE OF RELATED APPLICATIONS

This application claims the benefit of Provisional Application No. 62/281,892, filed Jan. 22, 2016 and EP Application No. 16167400.7, filed Apr. 28, 2016.

### FIELD OF THE INVENTION

This disclosure relates to metallocene-catalyzed elastomers having low volatiles (e.g., solvent or diluent) content, compositions comprising such elastomers, and methods of making such elastomers. In particular, the disclosure relates to high Mooney viscosity metallocene-catalyzed elastomers, including ethylene-based elastomers such as EPDM rubbers, having low solvent and/or diluent content. Methods for making such elastomers include finishing processes that reduce and remove a surprisingly large amount of volatile solvents/diluents from a composition of a high viscosity elastomer containing such volatiles.

### BACKGROUND OF THE INVENTION

Many polymerization techniques include slurry or solution polymerization, in which the crude polymer product is obtained as a solution or slurry of the polymer in solvents/diluents. Typically, a volatile hydrocarbon liquid (e.g., hexane) is used as a solvent or diluent in such processes. Recovery of the solid polymer from the solution or slurry requires removing the volatile solvent/diluent; such processes are frequently referred to as “devolatilization” or “devol” for short.

Devolatilization may take many forms, including flashing and/or the use of water or steam stripping, followed by drying to remove excess water and solvent/diluent from the polymer, thereby recovering the relatively dry, solvent/diluent-free crumb. Drying may be accomplished by heating and/or through the use of dewatering and drying extruders. Some devol techniques include the use of an extruder without prior water/steam stripping, as disclosed for instance in U.S. Pat. No. 5,729,911 with respect to EP(D)M (ethylene, propylene, and optional diene copolymer) crumb. As disclosed in that patent and in U.S. Pat. No. 4,909,898, use of an extruder requires a polymer solution or slurry of adequate viscosity for the extruder to impart energy to the solution or slurry as it is forced through the extruder. Thus, some degree of concentration of the polymer (i.e., removal of some water) may be necessary prior to drying/dewatering extrusion of the polymer, such that the polymer is passed to the extruder in the form of wet crumb. As the wet crumb is forced through the extruder, mechanical work imparted on the wet crumb and subsequent extrusion through a die plate at moderate pressure results in further drying of the polymer.

However, each of these processes is highly energy-intensive, adding significant cost to the polymerization process. Although such processes are frequently utilized as part of the deashing required in Ziegler-Natta catalyzed polymerization processes, and also sometimes used in metallocene polymerization processes that include wet finishing, metallocene-catalyzed polymerization processes do not necessarily require such intensive deashing, and therefore frequently utilize different (non-wet) techniques for devolatilization.

For instance, a mixing apparatus such as a kneader or other like mixer may alternatively be used to devolatilize a polymer composition without addition of water or preliminary drying/concentration, as described in U.S. Pat. No. 8,524,859. The polymer composition comprising a slurry or solution of polymer in hydrocarbon liquid diluent or solvent is passed to the kneader, which may include internal rotating paddles, blades, stirrers, or other like devices for agitating and imparting shear to the polymer composition. As shear is imparted to the polymer composition, solvent is heated and volatilized, and vented from the kneader, preferably under vacuum. In addition, the mixing action of the kneader results in surface refresh (i.e., exposure of new polymer composition surface to the air within the kneader), allowing for greater ease of volatilization of diluent/solvent from the polymer composition.

However, devolatilization is particularly difficult for polymer compositions comprising highly viscous polymers, such as high Mooney viscosity elastomers (including, e.g., ethylene-based elastomers such as EP(D)M elastomers). For instance, U.S. Pat. No. 6,686,419 describes polymers having a broad range of Mooney viscosity (60-150 ML, 1+4 @ 125° C.), and separately states that flashing or liquid phase separation can remove solvent from such polymers such that solvent content is less than 0.1 wt %. However, in practice, such low volatile content is only possible at the low end of that Mooney range. As Mooney viscosity increases, and particularly as it increases past 80-85, processes such as flashing or liquid phase separation cannot remove sufficient amounts of volatiles (leaving, e.g., over 0.60 wt % volatile content behind in the polymer composition). Furthermore, even below to that upper limit, such devol processes become highly uneconomic due to their high energy use and excessive amounts of waste water created. In addition, the polymer product created by such processes generally takes the form of crumbs that must be further dried and then baled for packaging; pellets cannot be made from the product after such devol techniques.

In addition, forcing such highly viscous compositions through an extruder results in high internal pressure in the extruder, causing an excessive amount of work to be imparted to the polymer composition (thereby requiring high amounts of energy and likely excessively heating the polymer composition). Excessively heating the polymer composition may cause undesired breakdowns and/or reactions in the polymer product, such as undesired cross-linking of EPDM terpolymers or degradation of the polymer molecular weight (especially in the longer polymer chains within the polymer product, thereby changing molecular weight distribution, in turn negatively effecting many polymer properties). In addition to these downsides, even attempting to run high viscosity polymer compositions through an extruder for devolatilization would require specialized screw configurations distinct from typical configurations, which would require either a specialized extruder for high viscosity polymer production (extra equipment cost) or costly downtime in a commercial polymerization plant for screw reconfiguration between runs of different polymers. In sum, polymers having Mooney viscosity over 65 MU (Mooney units), and particularly polymers having Mooney viscosity over 85 MU are at a minimum very difficult to devolatilize in extruders, if such could even be considered feasible, and frequently contain excessive amounts of diluent or solvent (e.g., greater than 0.60 wt %) in the final polymer product.

Kneaders likewise typically fail to adequately devolatilize highly viscous polymer compositions; however, as detailed below, the present inventors have discovered a counterintuitive devol technique using kneaders that surprisingly allows for the production of high viscosity, low-volatile metallocene-catalyzed polymers.

### SUMMARY OF THE INVENTION

The present inventors have surprisingly discovered a new devolatilization process for solutions or slurries of highly viscous polymer, such as EP(D)M rubber, that avoids the formation of crumbs while still imparting adequate work to the polymer composition to volatilize the liquid hydrocarbons contained therein. In particular, the devolatilization process involves use of a kneader or like mixing apparatus for devolatilization, wherein the kneader is counterintuitively operated at low RPM. As explained in more detail herein, such operation enables the production of high Mooney viscosity polymers, especially high Mooney viscosity metallocene-catalyzed elastomers, having low volatiles content.

Thus, the present invention in some aspects resides in highly viscous devolatilized elastomer compositions, processes for making such elastomer compositions, and elastomeric compounds formed from such devolatilized elastomer compositions.

The highly viscous devolatilized elastomer composition in some embodiments comprises a metallocene-catalyzed elastomer, such as a metallocene-catalyzed EP(D)M. The devolatilized elastomer composition of such embodiments may have Mooney viscosity greater than 65 MU (preferably 90 MU or greater), and low volatiles content (preferably 0.60 wt % or less, combined, of any hydrocarbon liquids and/or any other volatiles, such as water, that may be present in an elastomer stream provided to a kneader). Put another way, the devolatilized elastomer composition of certain embodiments comprises at least 99.40 wt % elastomer solids.

The invention further resides in elastomeric compounds made from such a devolatilized elastomer composition. Such compounds may comprise the devolatilized elastomer composition and one or more additives typically found in EPDM formulations, such as carbon black and/or other fillers, processing oils, zinc oxides, curing agents and co-agents, and the like.

The processes for forming such devolatilized elastomer compositions include (a) preparing an elastomer stream comprising elastomer solids and hydrocarbon liquids; (b) introducing the stream into a kneader; and (c) operating the kneader so as to obtain a devolatilized elastomer composition having Mooney viscosity of greater than 85 MU, preferably greater than 90 MU, such as from 90-100 MU. The kneader may comprise a plurality of paddles (equivalently referred to as blades) disposed within an outer housing, and preferably extending radially outward from a central axis within the housing. The paddles may be operated such that they rotate at 15 rotations per minute (rpm) or less, preferably 10 rpm or less. Such reduced speed of operation as compared to speeds used for lower viscosity polymers counterintuitively provides for better devolatilization of the highly viscous elastomer stream introduced into the kneader of such embodiments. In yet further embodiments, the operating RPM of the kneader is determined based at least in part upon the elastomer viscosity (e.g., in an inversely proportional manner) to optimize mechanical work input and surface refresh.

### BRIEF DESCRIPTION OF THE DRAWINGS

FIG. 1 is a cross-sectional schematic of a kneader useful in accordance with some embodiments of the present invention.

FIG. 2 is a cross-sectional end-view schematic of a kneader useful in accordance with some embodiments of the present invention.

FIG. 3 is a schematic of a hook-shaped stationary member disposed within a kneader that is useful in accordance with some embodiments of the present invention.

FIGS. 4A and 4B are schematics of shearing paddles.

FIG. 5 is a plot of sample data from two experimental runs of elastomer stream through a kneader.

### DETAILED DESCRIPTION OF THE EMBODIMENTS

As noted, in some aspects the invention resides in a polymerization process that includes devolatilization in a kneader or other like mixing apparatus (sometimes referred to herein solely as a “kneader” for convenience, although any apparatus in which a polymer mass may be subjected to shear and agitation is also contemplated by such term). The kneader is counterintuitively operated at low rpm (rotations per minute) of the paddles, blades, or other like apparatus in the kneader for agitating and imparting shear to the polymer composition. Such low rpm operation reduces the surface refresh rate and amount of shear imparted to the polymer composition, both of which (as detailed below) are typically thought of as having negative impacts on devolatilization of a polymer mass. However, the present inventors have recognized that relatively high-speed agitation of highly viscous polymer compositions in a kneader results in formation of small, discrete crumbs that are moved through the kneader without being sheared. The kneader therefore fails to refresh the surface area of the polymer composition and to impart any energy to the crumbs, thereby resulting in minimal volatilization of diluent/solvent. Instead, an unacceptably high degree of diluent/solvent remains trapped within the polymer crumbs. By avoiding this crumb formation in the kneader, one can still impart an acceptable degree of shear and agitation to the polymer composition to achieve the desired surface refresh and volatilization of hydrocarbon liquids (e.g., diluent or solvent) from the polymer composition.

### Definitions

Definitions applicable to the presently described invention are as described below.

As used herein, wt % means percent by weight, or weight percentage, and wppm means parts per million, on a weight basis. Unless otherwise indicated, percentages and ppm values should be assumed to be wt % and wppm.

As used herein, a “Cₓ hydrocarbon,” where x is an integer, refers to a hydrocarbon compound having X carbon atoms. Thus, a C₆ hydrocarbon is a hydrocarbon having 6 carbon atoms. Similarly, a “Cₓ-C_{y} hydrocarbon” or a “C_{x-y} hydrocarbon” is a hydrocarbon having from x to y carbon atoms, inclusive (e.g., a C₆-C₁₀ or C₆₋₁₀ hydrocarbon is a hydrocarbon having 6, 7, 8, 9, or 10 carbon atoms).

“Diluent” means a diluting or dissolving agent. Diluent is specifically defined to include chemicals that can act as dissolving agents, i.e., solvents, for the Lewis Acid, other metal complexes, initiators, monomers, or other additives, but which preferably do not act as dissolving agents for the elastomer obtained through polymerization of the dissolved monomers. In the practice of the invention, the diluent does not alter the general nature of the components of the polymerization medium, i.e., the components of the catalyst system, monomers, etc. However, it is recognized that interactions between the diluent and reactants may occur. In preferred embodiments, the diluent does not react with the catalyst system components, monomers, etc., to any appreciable extent. Additionally, the term diluent includes mixtures of at least two or more diluents. Diluents, in the practice of the invention, are generally hydrocarbon liquids, which may be halogenated with chlorine or fluorine as disclosed in U.S. Pat. No. 7,232,872.

“Solvent” means a hydrocarbon liquid that is capable of acting as a dissolving agent for an elastomeric polymer. Solvents, in the practice of this invention, are generally hydrocarbon liquids having the formula CₓH_{y}, wherein x is 5 to 20, and y is 12 to 22, such as hexane, isohexane, pentane, iso-pentane, and cyclohexene.

The term “elastomer,” as used herein, refers to any polymer or combination of polymers consistent with the ASTM D1566 definition of “a material that is capable of recovering from large deformations, and can be, or already is, modified to a state in which it is essentially insoluble (but can swell) in boiling solvent.” As used herein, the term “elastomer” may be used interchangeably with the term “rubber.” Preferred elastomers have a melting point that cannot be measured by DSC or if it can be measured by DSC is less than 50° C., or preferably less than 30° C., or less than 0° C. Preferred elastomers have a Tg of −20° C. or less as measured by DSC.

“Mooney viscosity” as used herein is the Mooney viscosity of a polymer or polymer composition. Unless otherwise indicated, Mooney viscosity is measured using a Mooney viscometer according to ASTM D-1646, but with the following modifications/clarifications of that procedure. First, sample polymer (100-150 g instead of the 250 g indicated in ASTM D-1646) is massed on a roll mill prior to testing. The mill temperature is 145° C.+/−10° C. instead of the 50+/−5° C. recommended in ASTM D-1646, because 50° C. is insufficient to cause sufficient massing. Further, although ASTM D-1646 allows for several options for die protection, should any two options provide conflicting results, PET 36 micron should be used as the die protection. Further, ASTM D-1646 does not indicate a sample weight in Section 8; thus, to the extent results may vary based upon sample weight, Mooney viscosity determined using a sample weight of 21.5+/−2.7 g in the ASTM D-1646 Section 8 procedures will govern. Finally, the rest procedures before testing set forth in D1646 Section 8 are 23+/−3° C. for 30 min in air; ML as reported herein were determined after resting at 24+/−3° C. for 30 min in air. The results are reported as ML (1+4 @ 125° C.), where M is the Mooney viscosity number, L denotes large rotor (defined as ML in ASTM D1646-99), 1 is the pre-heat time in minutes, 4 is the sample run time in minutes after the motor starts, and 125° C. is the test temperature. Thus, a Mooney viscosity of 90 determined by the aforementioned method would be reported as a Mooney viscosity of 90 (1+4 @ 125° C.). Alternatively, the Mooney viscosity may be reported as 90 MU; in such instance, it should be assumed that the just-described method is used to determine such viscosity, unless otherwise noted.

The torque limit of the Mooney viscometer is about 100 Mooney units (MU). Mooney values greater than about 100 Mooney units generally cannot be measured under these conditions. In this event, a non-standard rotor design is employed with a change in Mooney scale that allows the same instrumentation on the Mooney viscometer to be used for more viscous polymers. This rotor is both smaller in diameter and thinner than the standard ML rotor, and thus it is termed MST (Mooney Small-Thin). MST methods may be used to determine viscosity of polymers having viscosity greater than 100 Mooney units as described in Col. 5, lines 15-52 of U.S. Pat. No. 9,006,332, which description is incorporated herein by reference. In particular, MST may be determined and reported as (MST, 5+4 @ 200° C.), meaning a 5 minute pre-heat and 4-minute torque recording at 200° C. is used with the MST rotor. Further, the MST Mooney value (MST, 5+4 @ 200° C.) may be converted back to the Mooney Large (ML, 1+4 @ 125° C.) scale as described at Column 6, lines 35-44 in U.S. Pat. No. 7,915,354, which description is hereby incorporated by reference.

### Avoiding Crumb Formation in Devolatilization of an Elastomer Stream

The processes of some embodiments include (i) preparing an elastomer stream comprising elastomer solids and hydrocarbon liquids, (ii) introducing the elastomer stream into a kneader, and (iii) operating the kneader so as to remove the hydrocarbon liquids, thereby obtaining a devolatilized elastomer composition comprising the elastomer solids and at most 0.60 wt % hydrocarbon liquids (and any other volatile components that might have been present in the elastomer stream provided to the kneader), the wt % based on total weight of the devolatilized elastomer composition. Preferably, the devolatilized elastomer composition comprises at most 0.35 wt % hydrocarbon liquids (and any other volatile components), more preferably at most 0.30, 0.25, 0.20, or 0.15 wt %, most preferably at most 0.1, 0.05 or 0.01 wt %. Put another way, the devolatilized elastomer composition comprises at least 99.60 wt % (such as at least 99.65 wt % or even at least 99.70, 99.75, 99.80, 99.85, or even more preferably 99.9, 99.95 or 99.99 wt %) elastomer solids. The elastomer solids are highly viscous, such that the devolatilized elastomer composition has a Mooney viscosity (ML, 1+4 @ 125° C.) of at least 65 MU, preferably at least 85 MU, more preferably at least 90 MU, even at least 95 MU or 100 MU. The Mooney viscosity of the devolatilized elastomer composition may be as high as 150 MU, or more preferably as high as 110 MU (ML, 1+4 @ 125° C.).

Preferably, the kneader comprises a plurality of rotating members (i.e., paddles or the like) disposed within an outer housing, wherein the paddles are capable of being rotated such that at least one surface of each paddle passes adjacent to another surface within the kneader (e.g., an inner wall of the kneader's housing, or one or more hooks or other projections extending into the kneader from the inner wall of the kneader's housing) during the rotation of the paddle. In this manner, rotation of the paddles both agitates and imparts shear to the elastomer stream within the kneader (e.g., by grinding a portion of the stream between the paddle and the surface along which the paddle passes as it rotates). Examples of suitable kneader configurations according to some embodiments are discussed in greater detail below.

In order to obtain the surprising combination of high viscosity and low hydrocarbon liquids content, the devolatilizing kneader must be operated in a counterintuitive manner—specifically, by operating the kneader's internal rotating members (e.g., paddles) at lower speed (lower rpm).

Typically, it is believed that the paddle rotation of such a kneader should be carried out at relatively high rotations per minute (rpm) in order to accomplish two goals: (1) maximize surface refresh rate of the elastomer stream in the kneader and (2) impart greater shear to the portion of the elastomer stream grinded between the paddle and the inner surface along which the paddle passes. With respect to (1), the faster the paddles are rotated, the more quickly new portions of the elastomer stream are exposed to the air within the kneader, allowing volatile hydrocarbon fluids to escape from the elastomer stream. For elaboration on this concept, please see Ramon Albalak, Polymer Devolatilization (CRC Press, 1996). With respect to (2), the faster grinding or shearing action imparts mechanical energy to the elastomer stream at a faster rate; such faster transfer of energy results in increased rate at which volatile hydrocarbon fluids are volatilized from the elastomer stream through surface refresh. When operated in such a manner, the elastomer stream is maintained in a continuous toffee-looking phase within the kneader. In addition to the aforementioned advantages, this continuous phase also allows for uniform torque loading along the kneader in an axial direction (from upstream to downstream, relative to the flow of the elastomer stream in the kneader).

This continuous toffee-looking phase, however, dissolves into a crumbly mass when the elastomer stream contains high Mooney elastomers. It is very difficult to impart shear or refresh surface area for this crumbly mass; the elastomer stream crumbs are rarely ground or sheared between the paddle and the surface along which the paddle passes as it rotates, thereby making it difficult to impart shear and mechanical energy to the elastomer stream. Furthermore, most of the elastomer crumbs remain intact as they are mixed in the kneader; thus, there is little surface refresh (since the crumb surfaces remain exposed to air, while their interiors are not). Finally, these crumbs tend to accumulate at the discharge zone of the kneader, increasing torque loading in that zone, which thereby increases the risk of equipment damage.

Without wishing to be bound by theory, the present inventors believe that this crumbly behavior is linked to the increased relaxation time τ exhibited by high Mooney viscosity elastomers. Similar to a spring and dashpot in parallel, polymer chains when subjected to outside forces (e.g., extension or shear) will deform; once the force is removed, the polymer chain returns to its “normal” (i.e., its thermodynamically-favored) configuration (or near to it). Conceptually, relaxation time τ may be taken as the time associated with the deformed polymer chain's return to thermodynamically-favored configuration. For instance, in the kneader, it is believed that the rotating members (e.g., paddles) of the kneader shear and extend elastomer chains when the elastomers are grinded and stretched/sheared between the rotating paddles and surface along which those paddles pass. With increased relaxation time associated with higher viscosity elastomers, the elastomer chains cannot restore to their thermodynamically-favored configuration post-deformation before being subjected to further deforming forces in the kneader. Thus, the continuous toffee-looking phase will be broken into domains of finite size, exhibiting the aforementioned crumbly behavior.

By operating the kneader's internal rotating members at lower rpm (contrary to the goals (1) and (2) noted above), it is theorized that the high viscosity elastomers are given enough time to return to their thermodynamically-favored configuration, thereby eliminating the discrete domains of finite polymer size. This should restore the elastomer stream to its continuous toffee-like phase.

In particular embodiments, then, the kneader's internal rotating members (e.g., paddles) should be operated at no more than 15 rpm, preferably no more than 12 rpm, such as no more than 11 or even 10 rpm. In some embodiments, the kneader paddles are operated at a maximum rpm of any one of 9, 8, 7, 6, and 5 rpm. In certain embodiments, the rpm may vary with respect to time during the course of the kneader operation. In such instances, the operating rpm of the kneader should be taken as the time-averaged operating rpm over time during the devolatilization of the collected elastomer product. That is, where “maximum” rpm is stated to be 11 according to the aforementioned embodiments, this means that the rpm as averaged over the time of collection of the devolatilized elastomer composition is no greater than 11 (even though rpm may at some point(s) during operation exceed 11 rpm, while at other point(s) remain under 11).

The ordinarily skilled artisan with the benefit of this disclosure will recognize that kneader maximum rpm may vary depending upon the Mooney viscosity of the elastomer solids within the elastomer stream provided to the kneader, and depending upon the desired minimum throughput of the elastomer stream through the kneader. In particular, suitable maximum rpm will vary inversely with respect to elastomer Mooney viscosity (i.e., the higher the viscosity, the lower the suitable maximum rpm). For instance, in embodiments where elastomer Mooney viscosity is within the range from 90-95 (ML, 1+4@125° C.), kneader rpm (i.e., as averaged over time during which devolatilized elastomer composition is collected) may be less than or equal to 15 rpm, such as less than or equal to 13 rpm, preferably less than 12 or even 11 rpm, such as about 10 rpm. Where elastomer Mooney viscosity is within the range from 95-100 (ML, 1+4@125° C.), preferred rpm may be 12 rpm or less. Where elastomer Mooney viscosity is within the range from 100-105 (ML, 1+4@125° C.), preferred rpm may be 11 rpm or less, more preferably 10 rpm or less or 9 rpm or less, and so forth.

On the other hand, however, the slower the rpm, the longer the residence time required for sufficient mechanical energy to be imparted to the elastomer stream (i.e., the lower the throughput allowed); at some point, low enough rpm may render the process uneconomical due to low throughput required for such low rpm. Therefore, kneader operation according to some embodiments calls for a minimum of 3, 4, 5, 6, or 7 rpm (as permitted by the aforementioned upper limits of operating rpm).

Nonetheless, processes according to various embodiments may advantageously allow for commercially significant throughput of elastomer stream through the kneader, while still achieving the acceptably low hydrocarbon liquids content previously described. For instance, in certain embodiments, elastomer stream throughput (measured as the rate of devolatilized elastomer composition exiting the kneader) may be at least 8,000 kg/hr, such as at least 9,000 kg/hr, more preferably at least 9,500 kg/hr (in terms of lb/hr: about 17,637; 19,842; and 20,944 lb/hr, respectively). In operation according to some embodiments, upper limits of throughput are selected to maintain process safety and product quality (e.g., preventing overheating of the elastomer and/or damage to the kneader equipment). Thus, the elastomer stream throughput (i.e., rate at which devolatilized elastomer composition exits the kneader) may be within the range from a low of any one of the aforementioned throughputs to a high of any one of 13,500 kg/hr, 11,500 kg/hr, 11,000 kg/hr, and 10,000 kg/hr (in terms of lb/hr: about 29,762; 25,353; 24,251; and 22,046 lb/hr, respectively). It is surprising, and highly advantageous, to be able to achieve such relatively high throughput of high Mooney viscosity elastomer, while maintaining low content of hydrocarbon liquids in the devolatilized elastomer composition.

### Kneader Equipment

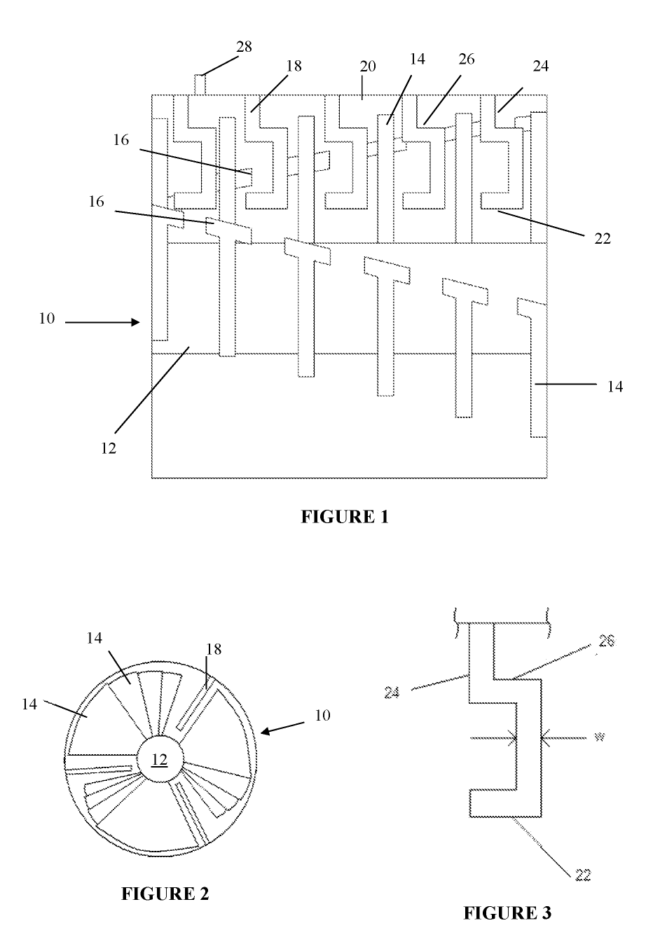

According to various embodiments, this technique may be practiced in any kneader or like mixing apparatus suitable for devolatilization/concentration of a polymer stream. Various elements of a particularly useful kneader according to some embodiments are illustrated in FIGS. 1-4B, described in more detail in the following paragraphs.

FIGS. 1 and 2 are illustrations of simple schematics for an exemplary kneader/concentrator 10. The kneader generally has a long cylindrical configuration having a defined length L to diameter D ratio of at least 1:1. The kneader 10 has a central core 12 located about the kneader's central axis. Along the outside length of the core 12 are at least two flights of shearing paddles; with three to ten flights in one embodiment, and four to eight flights in another embodiment. A “flight” of paddles is defined as a grouping or series of paddles along a common line or angle. The number of flights in the kneader is dependent on a variety of factors including the kneader diameter, the core diameter, and the width of each paddle 14. Each flight of paddles 14 contains at least four and up to 100 paddles. The number of paddles 14 is dependent on a variety of factors including the length of the kneader, the core diameter, the kneader diameter, the amount of shear energy desired to be generated in the elastomer. In FIG. 1, six paddles 14 are illustrated in two flights, while FIG. 2 illustrates three flights of four paddles each (from a head-on view down the central core 12).

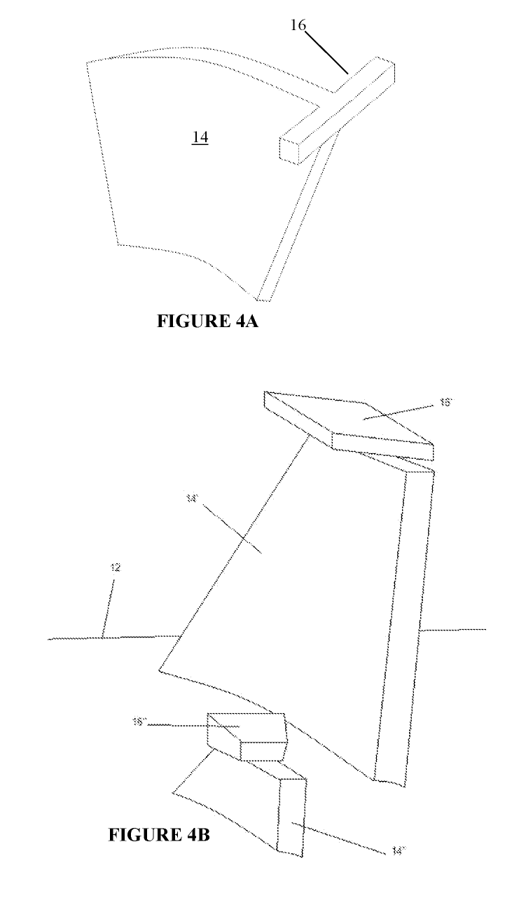

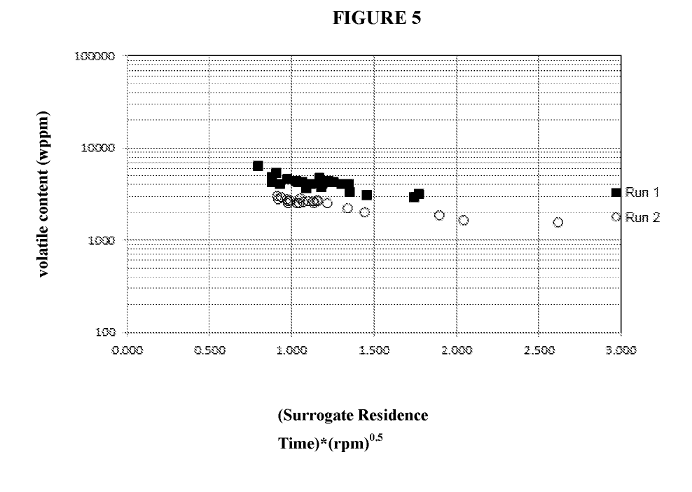

Each paddle flight extends at an angle along the longitudinal length of the central core 12; as the length of the kneader 10 and core 12 increases, the angle formed by each flight generates into a helical pattern about the core 12. For a long core length, each flight might fully wrap itself at least once about the core 12. Due to the angle, when the kneader is viewed from each end, a portion of each successive paddle 14 in each flight is visible, as shown in FIG. 2. In the illustrated kneader 10, each paddle 14 has a truncated triangular shape, see FIG. 4A. The width of the paddle 14 is measured across the transverse width of the core 12. At an upper edge of the paddle 14 is a clearing bar 16 (the orientation of paddle 14 in FIG. 4A is reversed from those in FIG. 1 for clarity of bar 16). The illustrated clearing bar 16 is oriented along a horizontal axis; however, to affect the flow of elastomer through the kneader, the bar 16 may be inclined at an angle relative to the horizontal axis. For example, the bar may form an angle of 5° to 30° to the horizontal axis. The radially innermost edge of the bar 16, relative to the kneader core 12, for such an angled bar 16 will enable the bar 16 to push the elastomer either back into the kneader for back-mixing of the elastomer or towards the exit to ensure movement of the elastomer through the kneader.

An alternative paddle 14′ is shown in FIG. 4B, wherein the clearing bar 16′ has a more slab-like configuration, thereby increasing the shearing surface of the paddle. Adjacent to the paddle 14′ is a secondary paddle 14″. The secondary paddle 14″ has a clearing bar 16″. The height of the secondary paddle 14″ is less than paddle 14′; as the secondary paddle 14″ is adjacent to the paddles 14 and 14′, the height is limited to not greater than the clearance between the core 12 and the bottom 22 of the kneading hooks 18 (see further discussion). The kneader 10 may comprise flights of the secondary paddle 14″—the flights of the secondary paddles 14″ having some or all of the same characteristics of the flights of paddle 14. In one embodiment, the number of paddles 14″ in each flight is one-half to one-fifth the number of primary paddles 14 in the kneader. The secondary paddles 14″ increase the shearing surface area in the kneader. The selective use and placement of the secondary paddles 14″ enables the elastomeric manufacturer to optimize the shear forces to which the elastomer is subjected.

As the core 12 rotates, the paddles 14 pass adjacent to kneading hooks 18 that extend from the outer wall 20 of the kneader 10. The kneading hooks 18 are also arranged in flights along the length of the kneader 10. Each kneading hook 18 has a radially inner terminal end 22 that does not contact the core 12. The kneading hook 18 is configured to obtain a desired surface area for shearing of the elastomer; this results in a combination of vertical shearing surfaces 24 and horizontal shearing surfaces 26. The kneading hook has at least one horizontal shearing surface 26 that has a width greater than the nominal width w of the kneading hook, as measured parallel to the angle formed by the kneading hook flight (see FIG. 3). If the hook 18 terminates in a horizontal orientation, as illustrated, the radially inner terminal end 22 also contributes to the horizontal shear surface area.

While the hooks 18 are illustrated as being mounted in a straight line (see FIG. 3) along the length of the kneader 10, the hooks 18 may also be arranged at an angle corresponding to or the inverse of the angle of the paddle flights. The number of hook flights may correspond to the number of paddle flights, see FIG. 3, or the number of hook flights may be more or less than the number of paddle flights.

The clearing bar 16 of the paddle 14 passes over the radially outermost horizontal shearing surface 26. By the interaction of the paddles 14 and the kneading hooks 18 as the core 12 rotates, elastomer present in the kneader 10, either in a solution or in a slurry, is sheared between the paddles and hooks. As the elastomer is subjected to the shearing forces, and the kneader is operated under vacuum conditions, the elastomer is heated and the volatiles are evaporated out of at least one vent 28.

In kneaders according to yet other embodiments, inward projecting members other than the hooks 18 illustrated in FIGS. 1-3 may be disposed within such kneaders. For instance, substantially straight members projecting radially inward from the kneader inner wall may be utilized, providing one or two shear surfaces along which paddles 14 of such embodiments pass.

Whatever the configuration, the speed of rotation (e.g., in rpm) of the paddles 14 is the parameter controlled to allow for devolatilization of elastomer streams containing high Mooney viscosity elastomers as described previously.

In one embodiment, the kneader 10 is initially filled to not more than 90% of the capacity volume of the kneader 10. In another embodiment, the kneader 10 is filled to not more than 60% of the kneader volume capacity. In yet another embodiment, the kneader 10 is filled to between 40% to 55% of the kneader volume capacity.

Following formation of the elastomer stream, the stream entering the kneader may be either a slurry containing precipitated elastomer or a solution containing dissolved elastomer; regardless, the stream has a defined elastomer content which may be expressed in terms of weight percent relative to the total weight of the stream, either the stream entering the kneader or the stream as exiting the kneader, depending upon which value is being discussed. The solids content of the entering stream is at least 10 wt %; in another embodiment, the entering stream is at least 20 wt % solids, is at least 30 wt % solids in yet another embodiment, and is in the range of 20 to 60 (such as 20 to 45) wt % solids in yet another embodiment. As the stream passes through the kneader, the solids content increases. In one embodiment, the final solid content of the exiting stream is greater than 20 wt % solids. In another embodiment, the final solid content of the exiting stream (i.e., the devolatilized elastomer composition) is at least 70 wt % solids, or at least 80 wt % solids. In another embodiment, the final solid content of the devolatilized elastomer composition is as set forth previously (e.g., at least 99.60 wt %, such as at least 99.65 wt % or even at least 99.70, 99.75, 99.80, 99.85, 99.95, or 99.99 wt %) elastomer solids. In yet other embodiments, the solids content of the devolatilized elastomer composition is in the range of 50 to 95 wt %, or in the range of 90 to 99.99 wt % (such as 90 to 99.9, or 90 to 99, or 90 to 95 wt %). In accordance with the invention, any of the above entering solids content may be treated to achieve any of the above cited higher exiting solids content. Concomitantly, the amount of solvent/diluent removed from the elastomer stream is also as set forth previously with respect to various embodiments (e.g., such that no more than 0.60 wt % or 6000 wppm hydrocarbon liquids and other volatile components are present, preferably no more than 0.35, 0.30, 0.25, 0.20, 0.15, 0.05, or 0.01 wt % hydrocarbon liquids and any other volatile components).

### Elastomer Streams

The kneader operation technique of the above-described embodiments may be applied to any elastomer stream comprising an elastomer solid and hydrocarbon liquid, but it is particularly useful for, and contemplated for use in connection with, an elastomer stream comprising an elastomer solid comprising a copolymer of ethylene, one or more α-olefins, and optionally one or more non-conjugated polyenes (such as one or more non-conjugated dienes). Suitable α-olefins include C₃-C₂₀ α-olefins, with propylene, 1-butene, and 1-octene preferred. Suitable non-conjugated polyenes include any polyene described in Paragraph [220] of U.S. Patent Publication No. 2015/0025209 (the description of which is incorporated herein by reference), with 5-ethylidene-2-norbornene (ENB) and/or 5-vinyl-2-norbornene particularly preferred. A preferred elastomer is EP(D)M, a copolymer of ethylene, propylene, and optionally one or more dienes (preferably including ENB and/or VNB, where the one or more dienes are present).

Preferred EPDM elastomers according to some embodiments comprise from 20-80 wt %, such as 50-80 wt %, 40-60 wt %, or 50-70 wt %, units derived from ethylene; 0.1-15 wt %, such as 0.1-10 wt %, 5-10 wt %, or 1-5 wt %, units derived from one or more non-conjugated polyenes; with the balance comprised of units derived from propylene (where the propylene units may be substituted in whole or in part by any other C₄-C₂₀ α-olefin(s)), the wt % s based upon the total weight of the EPDM elastomer. Ranges of comonomer content from any aforementioned low end to any aforementioned high end are also contemplated.

In certain embodiments, the EPDM elastomer may be a blend, such as a reactor blend, of two or more copolymer components (e.g., two or more EPDM components). As used herein, the term “reactor blend,” also sometimes referred to as an “intimate blend,” refers to a polymer composition comprising two or more fractions of polymer chains (e.g., the previously-referenced two or more copolymer components) made in the same reactor or in multiple reactors (either in series or parallel). A “series reactor blend” refers to a reactor blend produced by series polymerization (e.g., two or more polymerization reaction zones operated in series, such that at least a portion of the polymerization effluent from the first reaction zone is provided as feed to the second reaction zone). In such series reactor blends, the first polymer component may be considered as the polymer reaction product of the first reactor in the series reaction process (which polymer reaction product may be withdrawn from said first reactor for direct measurement of desired properties, such as molecular weights and/or Mooney viscosity, discussed in more detail herein). The second polymer component may be considered as the polymer reaction product of the second polymerization reactor in the series reaction process. Although direct measurement of properties of the second polymer component of such embodiments may be difficult (as the second polymer component will be intermixed with the first polymer reaction product in the effluent exiting the second polymerization reactor), properties of the overall series reactor blends may be measured (e.g., in the second effluent, containing both first and second polymer reaction products). Properties of the second polymer component may thereafter be calculated based upon the measured blend properties and the measured properties of the first polymer component, obtained per the above description. Calculations of relevant properties in such instances are described herein in connection with the property of interest.

Finally, more generally, a “blend” may refer to either a reactor blend, as just defined, or a physical (e.g., post-reactor) blend, such as made by physically mixing two or more polymer compositions in a mixer, extruder, or the like.

Returning to embodiments in which the EPDM elastomer is a series reactor blend, additional monomers (e.g., ethylene, propylene, and optionally diene monomers) may or may not be fed to the second polymerization reactor in addition to the portion (or entirety) of the first polymerization reactor effluent. In this manner, the effluent of the second polymerization reactor will contain some of the first polymerization effluent (e.g., unreacted polymer fed to the second reactor), in addition to polymers formed in the second reactor (from polymerization of the polymers in the first polymerization effluent, and/or unreacted monomers in the first polymerization effluent, and/or monomers fed directly to the second polymerization reactor, if any).

In a particular embodiment, the EPDM elastomer comprises a reactor blend of a first EPDM component and a second EPDM component. Each of the first and second EPDM components independently comprises from 50-80 wt %, such as 50-60 wt %, or in other embodiments 65-80 wt % (e.g., as 65-75 wt %) ethylene-derived units and from 5-10 wt %, or from 3.5-7.0 wt % (such as 4.0-6.5 wt %, or 4.5-6.0 wt %) non-conjugated polyene-derived units (e.g., units derived from a diene such as ENB), with the balance of each EPDM component comprising units derived from propylene and/or another C₄-C₂₀ α-olefin. The foregoing wt % s for each EPDM component are based upon the weight of the first or second EPDM component, respectively, and ranges from any aforementioned high end to any low end are also contemplated. In particular embodiments, the first and second EPDM components of such embodiments may include the same amount (within +/−2 wt %) of any one or more of the ethylene-derived units, non-conjugated polyene-derived units, and units derived from C₃-C₂₀ α-olefins (e.g., propylene). In certain other embodiments, the first and second EPDM components of such embodiments may include the same amount (within +/−0.5 wt %) of ethylene-derived units, while the second EPDM component has greater ENB content than the ENB content of the first EPDM component (e.g., the second EPDM component may have between 1.5 and 2.0 wt % more non-conjugated polyene-derived units than does the first EPDM component).

The reactor blend of some of these embodiments comprises 20-40 wt %, such as 25-35 wt %, of the first EPDM component, and 60-80 wt %, such as 75-85 wt %, of the second EPDM component, the wt % s determined on the basis of combined amount of first and second EPDM component in the reactor blend. In certain of these embodiments, the reactor blend comprises no polymer components other than the first and second EPDM copolymer components.

It is noted that in some instances, direct measurement of monomer contents of the second EPDM component may be difficult, particularly where the reactor blend comprises the product of two series polymerization reactors in which the first polymerization reactor effluent is fed to the second polymerization reactor, such that product withdrawn from the second polymerization reactor comprises both the first EPDM component and the second EPDM component. In such embodiments, there may be no product stream comprising the second EPDM component that does not also comprise the first EPDM component. However, the amount of units derived from a given monomer X in the second EPDM component of the reactor blend may be determined using the relationship:

X_{blend}=n_{A}X_{A}+n_{B}X_{B} (1)

where X_{blend} is the content (in wt %) of units derived from monomer X in the blend of two polymers A and B each having individual content (in wt %) of units derived from monomer X of X_{A} and X_{B}, respectively; and n_{A} and n_{B} represent the weight fractions of components A and B in the blend. With known monomer content for the blend and for the first EPDM component (e.g., component A in Equation (1)), and with known polysplit (i.e., wt % s of the first and second EPDM component in the blend), the monomer content of the second EPDM component (e.g., component B in Equation (1)) may readily be calculated.

Furthermore, in certain of these embodiments in which the elastomer comprises a reactor blend of two EPDM components, the first EPDM component may have Mooney small-thin viscosity of 50-80, such as 55-75 (MST, 5+4 @ 200° C.), while the Mooney viscosity of the reactor blend of such embodiments may be from about 70-110, such as 85-95, 86-95, or about 90 (ML, 1+4 @ 125° C.). As noted above, the second polymerization effluent in such reactor blend embodiments will contain both the first EPDM component (e.g., the polymers formed in the first series polymerization reactor) and the second EPDM component (e.g., polymers formed in the second series polymerization reactor). Thus, the measured viscosity of the second effluent is the viscosity of the blend. The viscosity of the second EPDM component alone is difficult to measure since the second component is intermixed with the first; however, the second EPDM component's viscosity may be calculated using the relationship:

log ML=n_{A} log ML_{A}+n_{B} log ML_{B} (2)

where ML is the Mooney large viscosity (ML, 1+4 @ 125° C.) of the blend of two polymers A and B each having individual Mooney viscosities ML_{A} and ML_{B}, respectively; and n_{A} and n_{B} represent the weight fractions of components A and B in the blend. As can be seen, since this relationship is in terms of ML, Mooney viscosities in (MST, 5+4 @ 200° C.) should first be converted to (ML, 1+4 @ 125° C.) as described previously.

It is particularly contemplated that, for elastomer streams comprising reactor blend EPDMs according to these embodiments, kneader operation of 15 rpm or less, preferably 11 rpm or even 10 rpm or less, is well-suited to produce the high-viscosity devolatilized elastomer compositions from such elastomer streams.

Other copolymers, such as propylene-based copolymers, or other α-olefin-based copolymers, whether reactor blends or otherwise, are also considered suitable for the practice of processes according to various embodiments. In general, then, suitable copolymers include copolymers (including blends such as reactor blends) of (i) two or more different C₂-C₂₀ α-olefins, and, optionally, (ii) one or more polyenes, preferably non-conjugated polyenes.

### Preparing the Elastomer Stream

Processes suitable for preparing the elastomer stream include any known solution or slurry polymerization process. The devolatilization processes described herein are particularly suited to metallocene polymerization processes, such as those using catalysts described in Col. 10, line 48 to Col. 12, line 37 of U.S. Pat. No. 6,686,419, which description is incorporated herein by reference. The polymerization processes described in the just-referenced description are also suitable in connection with embodiments of the present invention (e.g., the series reactor processes, useful in embodiments in which the elastomer comprises a reactor blend in accordance with the above description). Such processes may be carried out such that they are either solution or slurry processes. If the polymerization is a slurry polymerization, the hydrocarbon liquid is selected such that it may be characterized as a diluent (i.e., the resulting polymer will precipitate out of the solvent upon formation). In solution polymerization processes, the resulting polymer remains dissolved in the hydrocarbon liquid (i.e., such that the hydrocarbon liquid is characterized as a solvent).

In certain embodiments, preparing the elastomer stream comprises: copolymerizing a first C₂-C₂₀ α-olefin, a second C₂-C₂₀ α-olefin different from the first, and optionally one or more polyenes in the presence of a metallocene catalyst and one or more hydrocarbon liquids, thereby obtaining an elastomer stream comprising (i) solid elastomer comprising units derived from the first and second C₂-C₂₀ α-olefins and optionally from the one or more polyenes, and (ii) one or more of the hydrocarbon liquids. The elastomer stream is then introduced to a kneader, which is operated in a manner consistent with the above description of particular devolatilization techniques of some embodiments.

### Devolatilized Elastomer Compositions and Compounds Made Therefrom

Devolatilized elastomer compositions according to various embodiments may be prepared by any of the above-described processes. Further, some embodiments provide a devolatilized elastomer composition comprising (i) at least 99.4 wt % elastomer solids and (ii) at most 0.6 wt % hydrocarbon liquids and other volatiles, wherein the devolatilized elastomer composition has Mooney viscosity of at least 65 MU. Preferably, the devolatilized elastomer composition has Mooney viscosity of at least 85 MU, more preferably at least 90 MU, such as 95 or 100 MU.

The elastomer solids of such embodiments may comprise a copolymer in accordance with the previous description, preferably an ethylene-based copolymer such as an EP(D)M rubber. The copolymer is preferably metallocene-catalyzed.

Compounds made from the devolatilized elastomer composition include any typical EPDM formulation. That is, any of various known additives (plasticizers, compatibilizers, cross-linkers, and the like) may be formulated with the devolatilized elastomer compositions of certain embodiments, providing an elastomeric compound. Where cross-linking agents are utilized, the devolatilized elastomer composition may be present in the elastomeric compound in at least partially cross-linked form (that is, at least a portion of the polymer chains of the devolatilized elastomer composition are cross-linked with each other, e.g., as a result of a curing process typical for EPDM rubbers). Preferably, the devolatilized elastomer composition may be compounded with and/or cured using any one or more components (e.g., carbon black, fillers, curing agents), in accordance with the description at Col. 19, line 35 to Col. 20, line 3 of U.S. Pat. No. 7,915,354, which description is hereby incorporated by reference. Also or instead, additives in a compound comprising the devolatilized elastomer composition (cured or otherwise) may include antioxidants (e.g., Irganox 1076) and/or extension oil (e.g., paraffinic extension oil).

### EXAMPLES

### Example 1

Metallocene-catalyzed reactor blend EPDM was produced in two separate runs using two solution polymerization reactors in series, with isohexane as solvent. In each run, the EPDM component produced in the first reactor had about 71 wt % ethylene-derived units, 5 wt % ENB-derived units, and the balance polypropylene-derived units. This first EPDM component had Mooney viscosity of 65 (MST, 5+4 @ 200° C.). The first reactor effluent was fed to a second polymerization reactor, from which the reactor blend in hexane solvent was drawn as the second effluent. The elastomer solids of the second effluent had 71 wt % ethylene-derived content; 5.5 wt % ENB-derived content, with the balance of the elastomer solids derived from polypropylene. The reactor blend produced in each of the two runs had Mooney viscosity of 90 (ML, 1+4 @ 125° C.).

The reactor blend-in-solvent composition of the first run was then passed to a devolatilization kneader. During this Run 1 devolatilization, the reactor blend-in-solvent composition was continuously fed to the kneader as an elastomer stream. Sample was collected at regular time intervals during Run 1. During this run, the kneader was operated at an average of 13.9 rpm, with machine torque of the kneader maintained just below the maximum allowable torque to avoid damage to the kneader. During the course of the kneader operation, polymer product was discharged at temperatures ranging from 330° F.-420° F. (165.6° C.-215.6° C.).

To account for variations with respect to time in product flow rates, volume of the polymer in the kneader, and rpm, the value (surrogate residence time)*(rpm)^{0.5} for the kneader was recorded at each time a polymer sample was drawn at the kneader's exit. Surrogate residence time is a term used to account for both volume of elastomer stream in the kneader (i.e., fill) and mass flow rate (kg/min) of devolatilized elastomer exiting the kneader. Surrogate residence time is proportional to the residence time for a given polymer.

Residence time may be mathematically defined as V/Q, where V is the volume of elastomer stream in the kneader (m³) and Q is the mass flow rate (kg/min) of devolatilized elastomer composition exiting the kneader. V, the volume of polymers in the kneader at a given time, may be difficult to measure directly. Instead, V can be calculated from the following proportional relationship: torque=V*(polymer viscosity)*constant*f(RPM), where torque is the torque applied by the kneader to the elastomer stream (which may be measured as hydraulic pressure within the kneader). Polymer viscosity is measured for the exiting product, in terms of Mooney units (ML, 1+4@125° C.). The constant and f(RPM) relate the kneader RPM to shear rate experienced by polymers, and can be determined, for instance, based upon calibration using known volume of polymer of known viscosity in connection with measured torque values. That is, charging a known volume of polymer having known viscosity, and measuring torque (hydraulic pressure) of the kneader, one can determine the value of the constant for an elastomer stream of the given viscosity within the particular equipment through which the elastomer stream is being passed.

Table 1 shows the value (Surrogate Residence Time)*(rpm)^{0.5} for each of samples 1-1 to 1-28 drawn during Run 1. Table 1 also shows the volatile content (in wppm) found in each sample drawn during Run 1.

TABLE 1
Volatile Contents at 13.9 rpm
average kneader operation

| | (Surrogate | |
|---|---|---|
| | residence | Volatile |
| | time)* | content |
| Sample | (rpm)^{0.5} | (wppm) |
| 1-1 | 0.796 | 6291 |
| 1-2 | 1.043 | 4278 |
| 1-3 | 1.123 | 4002 |
| 1-4 | 1.188 | 4056 |
| 1-5 | 1.188 | 4349 |
| 1-6 | 1.307 | 4054 |
| 1-7 | 1.348 | 4059 |
| 1-8 | 1.256 | 4259 |
| 1-9 | 1.185 | 4263 |
| 1-10 | 1.179 | 4332 |
| 1-11 | 1.226 | 4281 |
| 1-12 | 1.185 | 4166 |
| 1-13 | 1.305 | 4005 |
| 1-14 | 1.211 | 4185 |
| 1-15 | 1.169 | 4696 |
| 1-16 | 0.973 | 4538 |
| 1-17 | 0.905 | 5365 |
| 1-18 | 0.883 | 4250 |
| 1-19 | 0.883 | 4759 |
| 1-20 | 1.031 | 4304 |
| 1-21 | 1.069 | 4242 |
| 1-22 | 1.185 | 3751 |
| 1-23 | 1.352 | 3282 |
| 1-24 | 1.091 | 3634 |
| 1-25 | 0.933 | 4053 |
| 1-26 | 1.459 | 3049 |
| 1-27 | 1.777 | 3107 |
| 1-28 | 1.744 | 2884 |

As can be seen, volatile content remained unacceptably high during this operation at 13.9 rpm average.

On the other hand, the second portion of 90 Mooney viscosity (ML, 1+4@ 125° C.) reactor blend EPDM was passed through the same kneader, and samples taken at regular intervals. During this Run 2, the kneader was operated at an average of 10.5 rpm. Table 2 shows the value (residence time)*(rpm)^{0.5} recorded for the kneader as each sample was taken during Run 2.

TABLE 2
Volatile contents at 10.5 rpm
average kneader operation

| | (Surrogate | |
|---|---|---|
| | residence | Volatile |
| | time)* | content |
| Sample | (rpm)^{0.5} | (wppm) |
| 2-1 | 2.621 | 1539 |
| 2-2 | 2.048 | 1635 |
| 2-3 | 1.901 | 1857 |
| 2-4 | 1.343 | 2217 |
| 2-5 | 1.443 | 1994 |
| 2-6 | 0.917 | 2722 |
| 2-7 | 1.104 | 2624 |
| 2-8 | 1.218 | 2465 |
| 2-9 | 1.141 | 2464 |
| 2-10 | 1.049 | 2465 |
| 2-11 | 1.073 | 2575 |
| 2-12 | 0.936 | 2899 |
| 2-13 | 0.913 | 2942 |
| 2-14 | 1.057 | 2824 |
| 2-15 | 1.133 | 2626 |
| 2-16 | 1.161 | 2683 |
| 2-17 | 1.157 | 2617 |
| 2-18 | 1.038 | 2514 |
| 2-19 | 0.980 | 2485 |
| 2-20 | 0.995 | 2657 |
| 2-21 | 0.981 | 2606 |
| 2-22 | 0.972 | 2748 |

As can be seen in Table 2, operating the kneader at slower rpm (10.5 rpm average over time of operation) for an elastomer stream of the same composition and viscosity resulted in much lower volatiles content, well within acceptable ranges. It can also be noted from Tables 1 and 2, that higher values of the proportional value (Surrogate Residence Time)*(rpm)^{0.5}, corresponding to lower values of Q (i.e., lower product throughput), also tend to result in lower volatile content. However, low product throughput leads to undesirable process economics; the data show that even at higher, more economically acceptable, product throughputs, the kneader rpm can be relatively slower in order to give adequately low volatile content for highly viscous elastomer. (This discussion assumes a desired relatively constant fill, V, in the kneader, representative of continuous polymerization processes.)

FIG. 5 is a graphical representation of the data set forth in Tables 1 and 2, showing both the Run 1 and the Run 2 volatile contents as a function of (Surrogate Residence Time)*(rpm)^{0.5}.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention. All documents described herein are incorporated by reference herein, including any priority documents and/or testing procedures to the extent they are not inconsistent with this text. Likewise, the term “comprising” is considered synonymous with the term “including.” Whenever a composition, an element or a group of elements is preceded with the transitional phrase “comprising,” it is understood that—unless the context plainly dictates otherwise—we also contemplate the same composition or group of elements with transitional phrases “consisting essentially of,” “consisting of,” “selected from the group of consisting of,” or “is” preceding the recitation of the composition, element, or elements and vice versa.

1. A polymerization process comprising:
(a) preparing an elastomer stream comprising an elastomer solid and one or more hydrocarbon liquids;
(b) introducing the stream into a kneader; and
(c) operating the kneader so as to obtain a devolatilized elastomer composition comprising at least 99.65 wt % of the elastomer solid, based upon the weight of the devolatilized elastomer composition;
wherein the devolatilized elastomer composition has a Mooney viscosity (ML, 1+4 @ 125° C.) of at least 90.

2. The process of claim 1, wherein the kneader comprises a plurality of paddles disposed within an outer housing of the kneader, such that the paddles are capable of being rotated such that at least one surface of each paddle passes adjacent to another surface within the kneader during rotation of the paddle, so as to agitate and impart shear to the elastomer stream, thereby volatilizing at least a portion of the one or more hydrocarbons from the stream.

3. The process of claim 1, wherein:
(i) the kneader has a central axis, an outer shell wall radially outward of the central axis, at least one flight of paddles extending radially outward from the central axis, and at least one flight of hooks extending radially inward from the outer shell wall toward the core, the hooks having at least one vertical shearing surface and at least one horizontal shearing surface greater than a nominal width of the hook, and
(ii) further wherein operating the kneader comprises shearing and/or extending the elastomer in the stream between the paddles and hooks, whereby the elastomer is subjected to shearing and/or extensional forces and at least a portion of the one or more hydrocarbon liquids is volatilized from the stream.

4. The process of claim 2, wherein operating the kneader comprises rotating the paddles at a rate of at most 12 rpm.

5. The process of claim 4, wherein operating the kneader comprises rotating the paddles at a rate of at most 10 rpm.

6. The process of claim 1, wherein
preparing the elastomer stream comprises: copolymerizing (i) a first C₂-C₂₀ α-olefin, (ii) a second C₂-C₂₀ α-olefin different from the first, and (iii) optionally, one or more polyenes in the presence of a metallocene catalyst and one or more hydrocarbon liquids, thereby obtaining an elastomer stream comprising (i) solid elastomer comprising units derived from the first and second C₂-C₂₀ α-olefins and optionally from the one or more polyenes, and (ii) one or more of the hydrocarbon liquids.

7. The process of claim 1, wherein the elastomer solid comprises EPDM.

8. The process of claim 7, wherein the EPDM comprises a reactor blend of a first EPDM component and a second EPDM component, and further wherein each of the first and second EPDM components independently comprises 50-60 wt % units derived from ethylene, 4.0-6.5 wt % units derived from one or more non-conjugated polyenes, with the balance of units derived from propylene, the wt % s based upon weight of each of the first and second EPDM components, respectively.

9. The process of claim 7, wherein the EPDM comprises a reactor blend of a first EPDM component and a second EPDM component, and further wherein each of the first and second EPDM components independently comprises 65-75 wt % units derived from ethylene, 4.0-6.5 wt % units derived from one or more non-conjugated polyenes, with the balance of units derived from propylene, the wt % s based upon weight of each of the first and second EPDM components, respectively.

10. The process of claim 9, wherein the ethylene content of the second EPDM component differs from the ethylene content of the first EPDM component by at most 2.0 wt %, and further wherein the non-conjugated polyene content of the second EPDM component differs from the non-conjugated polyene content of the first EPDM component by at most 0.5 wt %.

11. The process of any one of claim 9, wherein the first EPDM component has Mooney viscosity (MST, 5+4 @ 200° C.) of 50-80; and wherein the second EPDM component has Mooney viscosity (ML, 1+4 @ 125° C.) of 70-100.

12. The process of claim 1, wherein the elastomer stream comprises from 20 to 60 wt % elastomer solid, on the basis of the weight of the elastomer stream.

13. The process of claim 12, wherein the devolatilized elastomer composition comprises 0.05 wt % or less of hydrocarbon liquids and other volatile components.

14. The process of claim 12, wherein the devolatilized elastomer composition comprises at least 99.9 wt % solids.

15. A devolatilized elastomer composition comprising:
(i) at least 99.9 wt % of a metallocene-catalyzed elastomer comprising units derived from ethylene, a C₃-C₂₀ α-olefin, and one or more non-conjugated polyenes; and
(ii) at most 0.1 wt % hydrocarbon fluids and other volatile components, based upon the total weight of the elastomer composition;
wherein the devolatilized elastomer composition has Mooney viscosity of at least 90 (ML, 1+4 @ 125° C.).

16. The devolatilized elastomer composition of claim 15, wherein the metallocene-catalyzed elastomer is an EPDM elastomer.

17. The devolatilized elastomer composition of claim 16, wherein the EPDM elastomer is a reactor blend comprising a first EPDM component and a second EPDM component.

18. The devolatilized elastomer composition of claim 17, wherein each of the first and second EPDM components independently comprises 65-75 wt % units derived from ethylene, 4.5-6.0 wt % units derived from one or more non-conjugated polyenes, with the balance of units derived from propylene, the wt % s based upon weight of each of the first and second EPDM components, respectively.

19. The devolatilized elastomer composition of claim 17, wherein the ethylene content of the second EPDM component differs from the ethylene content of the first EPDM component by at most 2.0 wt %, and further wherein the non-conjugated polyene content of the second EPDM component differs from the non-conjugated polyene content of the first EPDM component by at most 0.5 wt %.

20. The devolatilized elastomer composition of claim 16, wherein the first EPDM component has Mooney viscosity (MST, 5+4 @ 200° C.) of 50-80; and wherein the second EPDM component has Mooney viscosity (ML, 1+4 @ 125° C.) of 70-100.

21. The devolatilized elastomer composition of claim 16, wherein the EPDM elastomer has Mooney viscosity (ML, 1+4 @ 125° C.) of at least 100.
